(19) United States
(12) Patent Application Publication
(10) Pub. No.: US 2005/0104811 A1
(43) Pub. Date: May 19, 2005

(54) Apparatus and method of driving a plasma display panel

(76) Inventors: Jeung Hwan Lee, Nam-gu (KR); Moon Shick Chung, Gumi-si (KR); Chang Hwan Koo, Jung-gu (KR); Jung Sub Shin, Yeongwol-gun (KR)

Correspondence Address: MCKENNA LONG & ALDRIDGE LLP;Song K. Jung, 1900 K Street, N.W., Washington, DC, 20006, US

(21) Appl. No.: 10/968,179

(22) Filed: Oct. 20, 2004

(30) Foreign Application Priority Data
Oct. 21, 2003 (KR) 10-2003-0073311

(51) Int. Cl. G09G 3/28

(52) U.S. Cl. 345/60

(57) ABSTRACT

The present invention relates to a plasma display panel and, more particularly, to an apparatus and a method of driving a plasma display panel. According to the present invention, an apparatus for driving a plasma display panel includes a line buffer unit synchronizing data inputted from outside with a horizontal synchronization signal to store per horizontal line, at least one comparison unit comparing loads included in horizontal lines stored in the line buffer unit, and a data converting unit correcting the data to be supplied to the horizontal lines using a load difference resulting from a comparison by the at least one comparison unit. According to the present invention, a method of driving a plasma display panel includes the steps of detecting loads included in externally inputted data to be supplied to at least two adjacent horizontal lines and correcting the data to be supplied to each of the at least two adjacent horizontal lines according to a load difference between the at least two adjacent horizontal lines. Accordingly, the loads included in the previous and current lines are computed to correct the data to be supplied to the lines according to the load difference between the respective lines, respectively. Therefore, the present invention enables to correct the brightness difference between the horizontal lines and to prevent power dispersion of the heavily-loaded horizontal line.

This Nonprovisional application claims priority under 35 U.S.C. § 119(a) on Patent Application No. 10-2003-0073311 filed in Korea on Oct. 21, 2003, the entire contents of which are hereby incorporated by reference.

### BACKGROUND OF THE INVENTION

1. Field of the Invention

The present invention relates to a plasma display panel and, more particularly, to an apparatus and a method of driving a plasma display panel.

2. Description of the Background Art

Generally, a plasma display panel (hereinafter abbreviated PDP) displays an image including characters and graphics in a manner of exciting a fluorescent substance by a 147 nm UV-ray emitted from a mixed gas discharge of (He+Xe), (Ne+Xe), or (He+Ne+Xe). PDP provides an excellent quality of image due to the recent development of technology as well as can be provided with a slim size and wide-screen. Specifically, a 3-electrodes AC surface discharge type PDP lowers its voltage necessary for an electric discharge using wall charges accumulated on a surface and protects its electrodes from sputtering that occurs on the electric discharge, thereby being advantageous in enabling a low voltage drive and long endurance.

FIG. 1 is a perspective diagram of a discharge cell of a 3-electrodes AC surface discharge type PDP according to a related art.

Referring to FIG. 1, a discharge cell of a 3-electrodes AC surface discharge type PDP consists of a scan electrode Y and sustain electrode Z formed on an upper substrate 10 and an address electrode X formed on a lower substrate 18. Each of the scan and sustain electrodes Y and Z has a line width smaller than that of a transparent electrode 12Y or 12Z and includes a metal bus electrode 13Y or 13Z provided to one side of the transparent electrode 12Y or 12Z.

The transparent electrodes 12Y and 12Z are generally formed of indium tin oxide (ITO) on the upper substrate 10. The metal bus electrodes 13Y and 13Z are generally formed of metal such as Cr or the like on the transparent electrodes 12Y and 12Z to reduce the voltage drops caused by the transparent electrodes 12Y and 12Z of high resistance, respectively. An upper dielectric layer 14 and protecting layer 16 are stacked over the upper substrate 10 including the scan and sustain electrodes 28Y and 29Z parallel to each other. Wall charges generated from plasma discharge are accumulated on the upper dielectric layer 14. The protecting layer 16 protects the upper dielectric layer 14 against sputtering caused by plasma discharge and increases discharge efficiency of secondary electrons. And, the protecting layer 16 is generally formed of MgO.

A lower dielectric layer 22 and barrier rib 24 are formed on the lower substrate 18 having the address electrode X formed thereon. A fluorescent layer 26 is coated on surfaces of the lower dielectric layer 22 and the barrier rib 24. The address electrode X runs in a direction crossing with the scan and sustain electrodes Y and Z. The barrier rib 24 is formed like a stripe or lattice shape to prevent UV and visible rays generated from electric discharge from leaking to neighbor discharge cells. The fluorescent layer 26 is excited by the UV-ray generated from plasma discharge to emit light including one of red, green, and blue visible rays. A mixed inert gas is injected in a discharge space provided between the barrier ribs 24 and the upper and lower substrates 10 and 18.

In order to implement gray levels of a picture in PDP, one frame is divided into several sub-fields differing in luminous times and is driven according to time division. And, each of the sub-fields is divided again into a reset period for resetting the entire screen, an address period for selecting a scan line and a cell on the selected scan line, and a sustain period for implementing gray levels according to a discharging number.

In this case, the initialization period is divided into a set-up period for supplying an ascent lamp waveform and a set-down period for supplying a descent lamp waveform. For instance, in case of displaying an image with 256 gray levels, a frame period (16.67 ms) corresponding to 1/60 second, as shown in FIG. 2, is divided into eight sub-fields SF1 To SF8. And, each of the eight sub-fields SF1 to SF8 is divided into a reset period, an address period, and a sustain period. The reset and address periods of the respective sub-fields are equal to each other, whereas the sustain periods of the respective sub-fields increase at a ratio of 2ⁿ (n=0, 1, 2, 3, 4, 5, 6, 7), respectively.

FIG. 3 is a block diagram of a driving apparatus of a plasma display panel according to a related art.

Referring to FIG. 3, a driving apparatus of a plasma display panel according to a related art consists of a first inverse gamma correction unit 32A, gain control unit 34, error diffusion unit 36, sub-field mapping unit 38, and data alignment unit 40 connected between an input line 1 and a panel 46. And, the driving apparatus also consists of a frame memory 30, second inverse gamma correction unit 32B, APL (average picture level) unit, and waveform generating unit 44 connected between the input line 1 and the panel 46.

Each of the first and second inverse gamma correction unit 32A and 32B performs inverse gamma correction on a gamma-corrected video signal to linearly vary a brightness value according to a gray level value of a video signal.

The frame memory 30 stores data (R,G,B) of one frame and supplies the stored data to the second inverse gamma correction unit 32B.

The APL unit 42 receives the video data corrected by the second inverse gamma correction unit 32B and then generates an N-step signal for adjusting a sustain pulse number. In this case, N is a natural number.

The gain control unit 34 amplifies the video data, which was corrected by the first inverse gamma correction unit 32A, by an effective gain.

The error diffusion unit 36 diffuses an error component of a cell into neighbor cells to adjust the brightness value minutely.

The sub-field mapping unit 38 reallocates the corrected video data from the error diffusion unit 36 per sub-field.

The data alignment unit 40 converts the video data inputted from the sub-field mapping unit 38 to fit a resolution format of the panel 46 and then supplies the converted data to an address drive integrated circuit (hereinafter abbreviated IC) of the panel 46.

The waveform generating unit 44 generates a timing control signal by the N-step signal inputted from the APL unit 42 and then supplies the generated timing control signal to the address drive IC, scan drive IC, and sustain drive IC of the panel 46.

In the related art driving apparatus for PDP, the APL unit 42 receives the video data and then computes a step of APL according to the received video data. In doing so, the sustain pulse number is determined to correspond to the APL step. If a load of the panel is great (i.e., if a great number of discharge cells are turned on), the APL step is set high. If a load of the panel is small (i.e., if a small number of discharge cells are turned on), the APL step is set low.

In this case, the APL step and the sustain pulse number, as shown in FIG. 4, are set inversely proportional to each other. In other words, the higher the APL step increases, the less the sustain pulse number decreases. The lower the APL step decreases, the more the sustain pulse number increases. Thus, once the inverse proportional relation is set between the APL step and the sustain pulse number, it is able to uniformly maintain the power consumed by the PDP to a certain extent.

In the related art PDP, a voltage value applied to a panel varies according to a load of the panel, i.e., according to the APL step. Specifically, in case that the load of the panel is low (i.e., in case that the APL step is low), a low current flows in the panel. Hence, if the load of the panel is low, a low voltage drop occurs in the panel so that a more or less stable voltage value (sustain voltage Vs low voltage-drop voltage) can be applied to the panel. Namely, in case that the load of the panel is low, it is able to trigger a stable sustain discharge. Yet, in case that the load of the panel is great (i.e., in case of high APL step), a high current flows in the panel. Hence, in case that the load of the panel is great, a high voltage drop occurs in the panel so that a low voltage value (sustain voltage value Vs high voltage-drop voltage) can be applied to the panel. Namely, in case that the load of the panel is great, the voltage value substantially applied to the panel is lowered to bring about an unstable sustain discharge. Hence, the brightness and reliability of the panel are degraded.

In order to solve the problem, in the related art PDP, by computing a load of total one frame, an APL curve of one frame is corrected to control an overall brightness. In doing so, since the brightness is corrected by computing the total one frame, it is unable to correct the brightness minutely. Hence, the demand for a PDP driving device enabling to correct a per horizontal line brightness recently rises.

### SUMMARY OF THE INVENTION

Accordingly, an object of the present invention is to solve at least the problems and disadvantages of the background art.

An object of the present invention is to provide a method of diving a plasma display panel and apparatus thereof, by which a per horizontal line brightness difference can be enhanced.

According to an embodiment of the present invention, an apparatus for driving a plasma display panel includes a line buffer unit synchronizing data inputted from outside with a horizontal synchronization signal to store per horizontal line, at least one comparison unit comparing loads included in horizontal lines stored in the line buffer unit, and a data converting unit correcting the data to be supplied to the horizontal lines using a load difference resulting from a comparison by the at least one comparison unit.

According to an embodiment of the present invention, a method of driving a plasma display panel includes the steps of detecting loads included in externally inputted data to be supplied to at least two adjacent horizontal lines and correcting the data to be supplied to each of the at least two adjacent horizontal lines according to a load difference between the at least two adjacent horizontal lines.

By the apparatus for driving the plasma display panel and method thereof according to the present invention, the data to be supplied to the lines according to a load difference between the respective lines can be corrected in a manner of computing the loads included in the previous and current lines. Therefore, the brightness difference between the horizontal lines can be corrected, whereby the power dispersion of the heavily-loaded horizontal line can be prevented.

### BRIEF DESCRIPTION OF THE DRAWINGS

The invention will be described in detail with reference to the following drawings in which like numerals refer to like elements.

FIG. 1 is a perspective diagram of a discharge cell of a 3-electrodes AC surface discharge type plasma display panel according to a related art.

FIG. 2 is a timing diagram of one frame of plasma display panel.

FIG. 3 is a block diagram of an apparatus for driving a plasma display panel according to a related art.

FIG. 4 is a graph of a sustain voltage value corresponding to an average picture level of a related art.

FIG. 5 is a block diagram of an apparatus for driving a plasma display panel according to a first embodiment of the present invention.

FIGS. 6A to 6C are cross-sectional diagrams for explaining a method of compensating a per line brightness difference using the driving apparatus shown in FIG. 5.

FIG. 7 is a block diagram of an apparatus for driving a plasma display panel according to a second embodiment of the present invention.

FIGS. 8A to 8C are cross-sectional diagrams for explaining a method of compensating a per line brightness difference using the driving apparatus shown in FIG. 7.

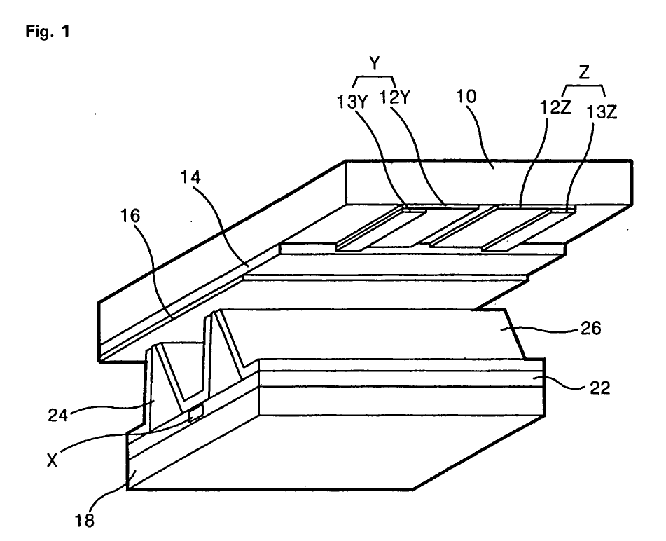

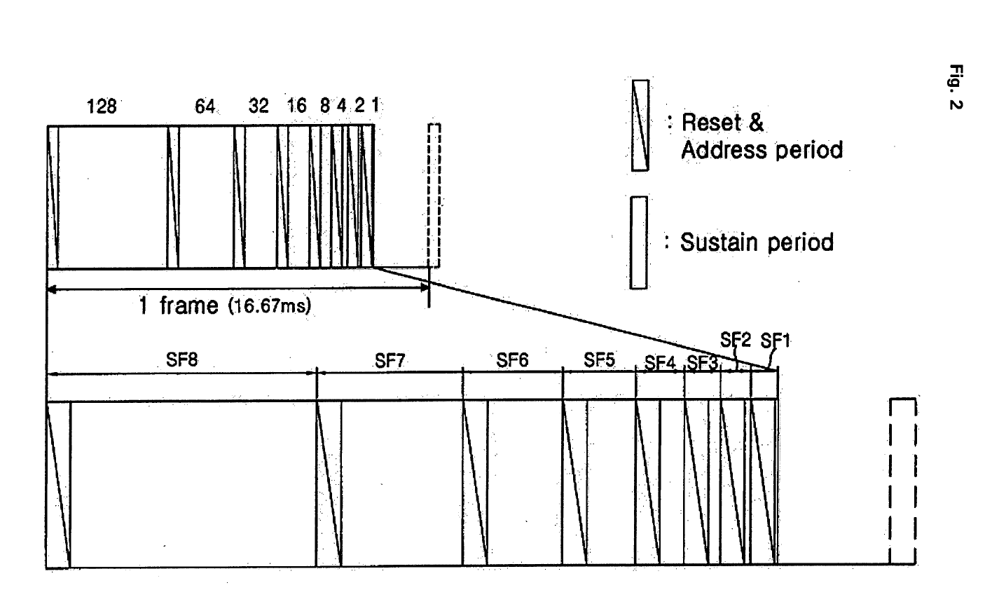

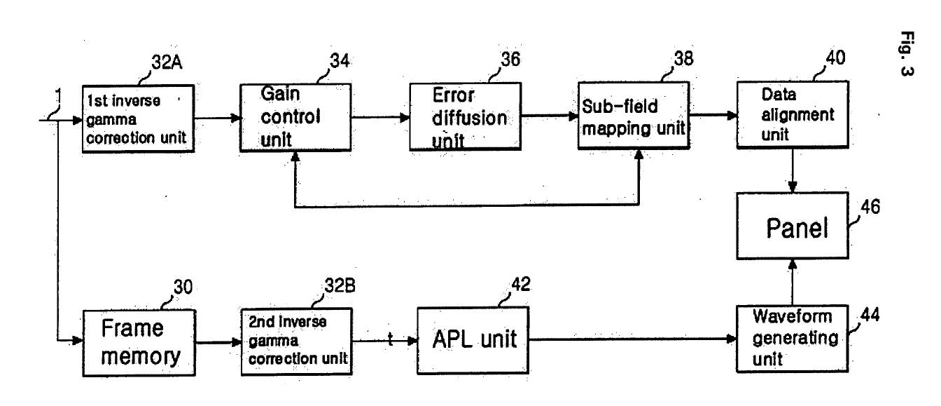

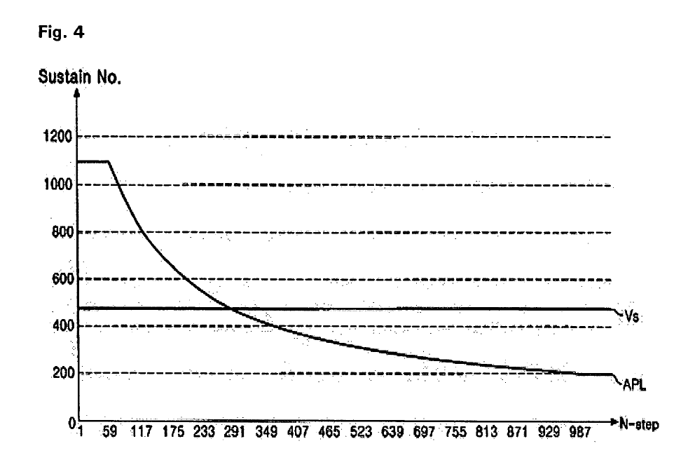

### DETAILED DESCRIPTION OF PREFERRED EMBODIMENTS

Preferred embodiments of the present invention will be described in a more detailed manner with reference to the drawings.

According to an embodiment of the present invention, an apparatus for driving a plasma display panel includes a line buffer unit synchronizing data inputted from outside with a horizontal synchronization signal to store per horizontal line, at least one comparison unit comparing loads included in horizontal lines stored in the line buffer unit, and a data converting unit correcting the data to be supplied to the horizontal lines using a load difference resulting from a comparison by the at least one comparison unit.

The at least one comparison unit includes a comparison unit comparing the load included in the data having been supplied to a previous horizontal line to the load included in the data to be supplied to a current horizontal line.

And, the at least one comparison unit includes a first comparison unit comparing the load included in the data supplied to a kth horizontal line to the load included in the data supplied to a (k+1)th horizontal line and a second comparison unit comparing the load included in the data supplied to the (k+1)th horizontal line to the load included in the data supplied to a (k+2)th horizontal line if the loads compared by the first comparison unit are identical to each other.

According to an embodiment of the present invention, a method of driving a plasma display panel includes the steps of detecting loads included in externally inputted data to be supplied to at least two adjacent horizontal lines and correcting the data to be supplied to each of the at least two adjacent horizontal lines according to a load difference between the at least two adjacent horizontal lines.

The step of detecting the loads included in the externally inputted data to be supplied to the at least two adjacent horizontal lines includes the steps of detecting a first load value included in a first externally inputted data supplied to first horizontal lines and detecting a second load value included in a second externally inputted data to be supplied to second horizontal lines synchronized with a horizontal synchronization signal.

The step of correcting the data to be supplied to each of the at least two adjacent horizontal lines according to the load difference between the at least two adjacent horizontal lines includes the steps of if a difference between the first and second load values is equal to or greater than a prescribed value, correcting the data to be relatively lower than the second data and supplying the corrected data to the second horizontal lines.

The step of correcting the data to be supplied to each of the at least two adjacent horizontal lines according to a load difference between the at least two adjacent horizontal lines includes the steps of if a difference between the first and second load values is smaller than a prescribed value, correcting the data to be relatively higher than the second data and supplying the corrected data to the second horizontal lines.

The step of detecting the loads included in the externally inputted data to be supplied to the at least two adjacent horizontal lines includes the steps of detecting a first load value included in a first externally inputted data supplied to a first horizontal line, detecting second load values included in second externally inputted data supplied to at least two second horizontal lines, respectively, and detecting a third load value included in a third externally inputted data supplied to a third horizontal line.

The second load values included in the data to be supplied to the at least two second horizontal lines, respectively are equal to each other.

The of correcting the data to be supplied to each of the at least two adjacent horizontal lines according to the load difference between the at least two adjacent horizontal lines includes the steps of comparing the first and second load values of the first and second horizontal lines, if a difference between the first and second load values is equal to or greater than a prescribed value, correcting the data to be relatively lower than the second data, and supplying the corrected data to the second horizontal lines.

And, the step of correcting the data to be supplied to each of the at least two adjacent horizontal lines according to the load difference between the at least two adjacent horizontal lines includes the steps of comparing the first and second load values of the first and second horizontal lines, if a difference between the first and second load values is smaller than a prescribed value, correcting the data to be relatively higher than the second data, and supplying the corrected data to the second horizontal lines.

Hereafter, the embodiments of the present invention will be described with reference to the drawings.

### First Embodiment

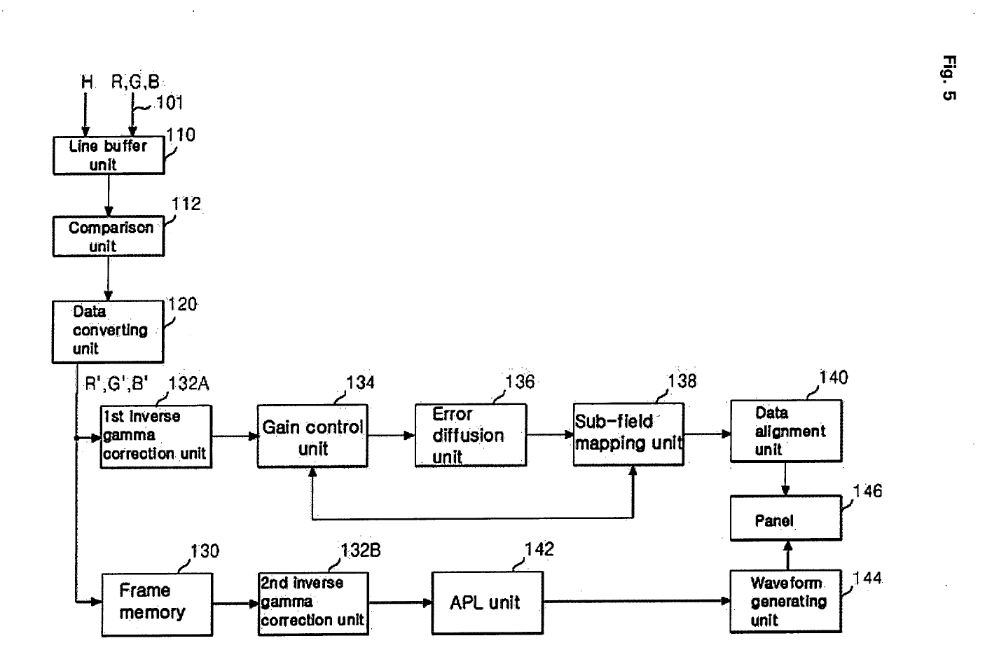

FIG. 5 is a block diagram of an apparatus for driving a plasma display panel according to a first embodiment of the present invention.

Referring to FIG. 5, an apparatus for driving a plasma display panel according to a first embodiment of the present invention includes a line buffer unit 110, comparison unit 112, data converting unit 120, first inverse gamma correction unit 132A, gain control unit 134, error diffusion unit 136, sub-field mapping unit 138, and data alignment unit 140 connected between an input line 101 and a panel 146. And, the apparatus according to the first embodiment of the present invention also includes a frame memory 130, second inverse gamma correction unit 132B, APL (average picture level) unit 142, and waveform generating unit 144 connected between the data converting unit 120 and the panel 146.

After having stored data of a kth horizontal line, the line buffer unit 110 synchronizes the data of the kth horizontal line and the data of a (k+1)th horizontal line with a horizontal synchronization signal H and then supplies the synchronized signal to the comparison unit 112. In doing so, the line buffer unit 110 computes to store a first load value included in the data of the kth horizontal line and then computes a second load value included in the inputted data of the (k+1)th horizontal line synchronized with the horizontal synchronization signal H.

The comparison unit 112 compares the first and second load values to each other to decide whether a load effect between the kth horizontal line and the (k+1)th horizontal line occurs.

The data converting unit 120 corrects data of one horizontal line which will be supplied to the line, in which it is decided that the load effect will occur by the comparison unit 112, and then supplies the corrected data to the first inverse gamma correction unit 132A and the frame memory 130. Namely, if the second load value included in the data of the (k+1)th horizontal line is relatively greater than the first load value, a level of the data of the (k+1)th horizontal line is lowered to a prescribed value since pixels supplied with the data of the (k+1)th horizontal line look relatively brighter. Alternatively, if the second load value included in the data of the (k+1)th horizontal line is relatively smaller than the first load value, the level of the data of the (k+1)th horizontal line is raised to a prescribed value since the pixels supplied with the data of the (k+1)th horizontal line look relatively darker.

Each of the first and second inverse gamma correction units 132A and 132B carries out inverse gamma correction on a video signal, which is gamma-corrected and of which level is selectively adjusted, to linearly change a brightness value according to a gray level value of the video signal.

The frame memory 130 stores data (R, G, B) amounting to one frame including data of at least one line of which level is selectively adjusted. And, the frame memory 130 supplies the stored data to the second inverse gamma correction unit 132B.

The APL unit 142 receives the video data corrected by the second inverse gamma correction unit 132B and then generates an N-step signal for adjusting a sustain pulse number. In this case, N is a natural number.

The gain control unit 134 amplifies the video data, which was corrected by the first inverse gamma correction unit 132, as many as an effective gain.

The error diffusion unit 136 diffuses an error component of the cell into neighbor cells, thereby adjusting a brightness value minutely.

The sub-field mapping unit 138 reallocates the corrected video data from the error diffusion unit 136 per sub-field.

The data alignment unit 140 converts the video data inputted from the sub-field mapping unit 138 to fit a resolution format of the panel 146 and then supplies the converted video data to an address drive integrated circuit (hereinafter abbreviated IC) of the panel 146.

And, the waveform generating unit 144 generates a timing control signal by the N-step signal inputted from the APL unit 142 and then supplies the generated timing control signal to the address drive IC, scan drive IC, and sustain drive IC of the panel 146.

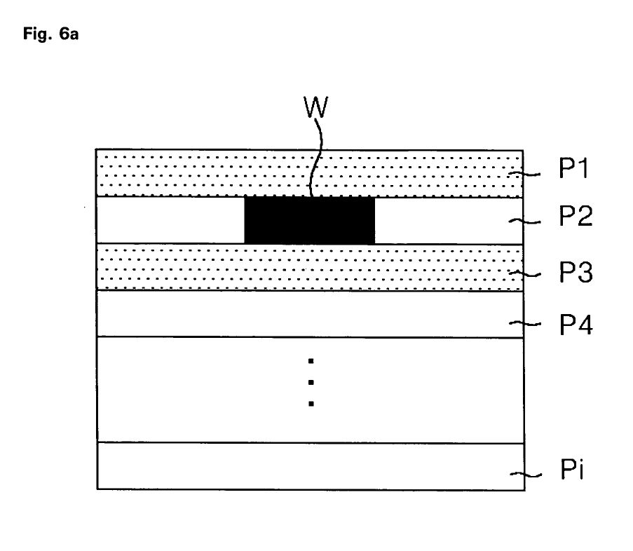

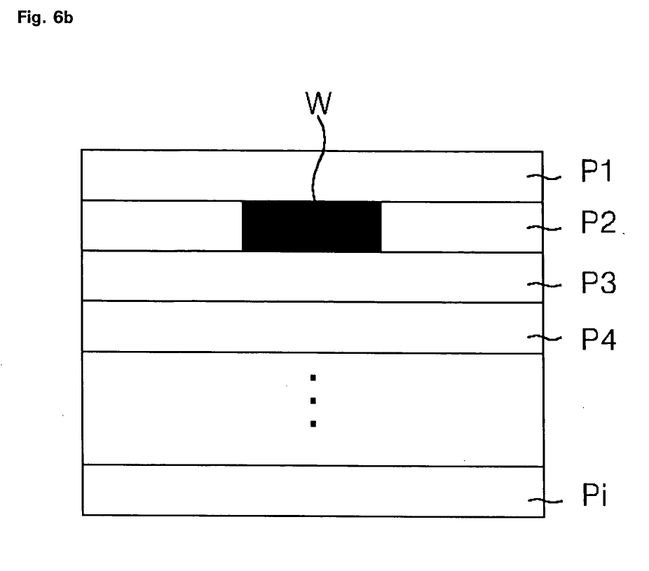

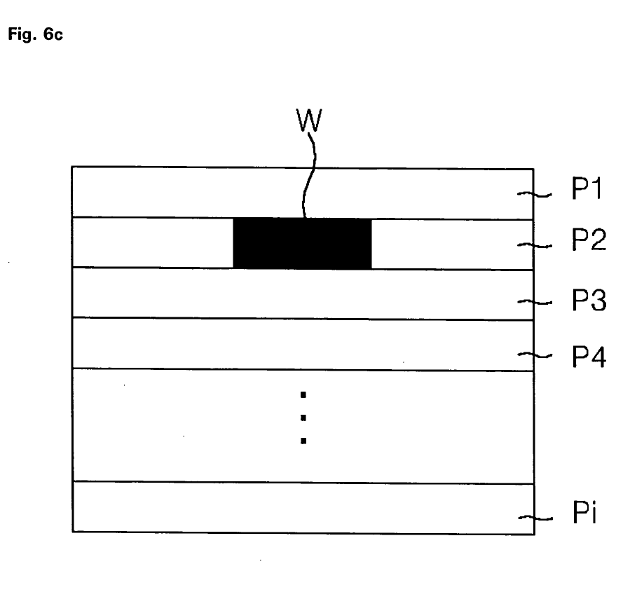

FIGS. 6A to 6C are cross-sectional diagrams for explaining a method of driving a plasma display panel according to a first embodiment of the present invention.

Referring to FIGS. 6A to 6C, first of all, a window area W of black gray is implemented on a specific area in a second pixel area P2 corresponding to a second horizontal line. And, in order to provide the same brightness to the second pixel area P2 except the window area W and first and third pixel areas P1 and P3 corresponding to first and third horizontal lines, data of the same level are supplied to the first to third pixel areas P1 to P3. In doing so, a load included in the data that will be supplied to the second pixel area P2 including the window area W is relatively greater than that of the data that will be supplied to the first or third pixel area P1 or P3.

In this case, the second pixel area P2 excluding the window area W, as shown in FIG. 6A, looks relatively brighter than the first or third pixel area P1 or P3 to which the data of the same level of the second pixel area is supplied.

Hence, the data, which will be supplied to the second pixel area P2 except the window area W, is corrected in a following manner. First of all, a load difference between the data, which will be supplied to the second pixel area P2 except the window area W, and another data that will be supplied to the first pixel area P1 corresponding to the first horizontal line or the third pixel area P3 corresponding to the third horizontal area is computed by the line buffer unit 110. The former data is then corrected in proportion to the load difference by a prescribed value. Namely, the data that will be supplied to the second pixel area P2 except the window area W, as shown in FIG. 6B, is corrected by a level relatively lower than that of the data that will be supplied to the first or third pixel area P1 or P3 and is then supplied to the second pixel area P2, whereby the first to third pixel areas P1 to P3 can be provided with the same brightness.

Thus, the level of the data, which will be supplied to the second pixel area P2 looking relatively brighter than the first or third pixel area P1 or P3, is lowered, whereby the brightness of the first to third pixel areas P1 to P3, as shown in FIG. 6C, except the window area W becomes identical.

### Second Embodiment

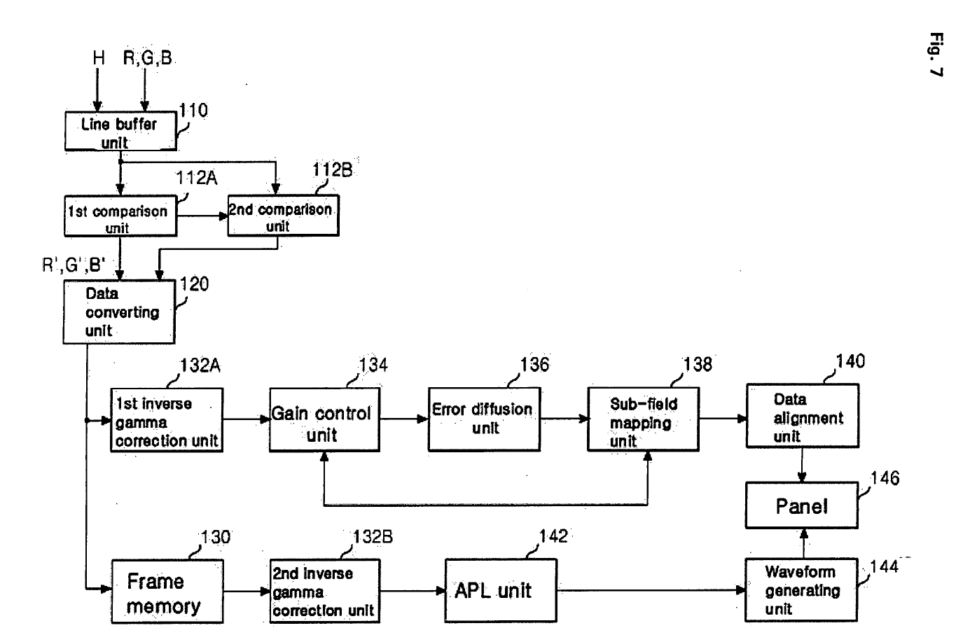

FIG. 7 is a block diagram of an apparatus for driving a plasma display panel according to a second embodiment of the present invention.

Referring to FIG. 7, an apparatus for driving a plasma display panel according to a second embodiment of the present invention includes the same elements of the apparatus according to the first embodiment of the present invention shown in FIG. 5 except that first and second comparison units 112A and 112B are provided between a line buffer unit 110 and a data converting unit 120.

After having stored data of at least two horizontal lines, the line buffer unit 110 computes load values included in the data of the at least two horizontal lines and then supplies the load values to the first and second comparison units 112A and 112B.

The first comparison unit 112A compares a first load value included in the data of a kth horizontal line and a second load value included in the data of a (k+1)th horizontal line to each other to decide whether a load effect between the kth horizontal line and the (k+1)th horizontal line occurs. Namely, if a difference between the first and second load values is equal to or greater than a prescribed value, the first comparison unit 112A supplies a load effect generation signal to the data converting unit 120. If there is no difference between the first and second load values, the first comparison unit 112A supplies a load effect non-generation signal to the second comparison unit 112B.

The second comparison unit 112B responds to the load effect non-generation signal in a following manner. First of all, the second comparison unit 112B compares the second load value included in the data of the (k+1)th horizontal line to a third load value included in the data of a (k+2)th horizontal line to decide whether a load effect between the (k+1)th horizontal line and the (k+2)th horizontal line occurs. Namely, if a difference between the second and third load values is equal to or greater than a prescribed value, the second comparison unit 112B supplies a load effect generation signal to the data converting unit 120. If there is no difference between the second and third load values, the second comparison unit 112B compares the third load value included in the data of the (k+2)th horizontal line and a load value of a (k+3)th horizontal line.

The data converting unit 120 corrects data of one horizontal line which will be supplied to the line, in which it is decided that the load effect will occur by the first and second comparison units 112A and 112B, and then supplies the corrected data to the first inverse gamma correction unit 132A and the frame memory 130. Namely, if the second load value included in the data of the (k+1)th horizontal line is relatively greater than the first load value, a level of the data of the (k+1)th horizontal line is lowered to a prescribed value since pixels supplied with the data of the (k+1)th horizontal line look relatively brighter. Alternatively, if the second load value included in the data of the (k+1)th horizontal line is relatively smaller than the first load value, the level of the data of the (k+1)th horizontal line is raised to a prescribed value since the pixels supplied with the data of the (k+1)th horizontal line look relatively darker.

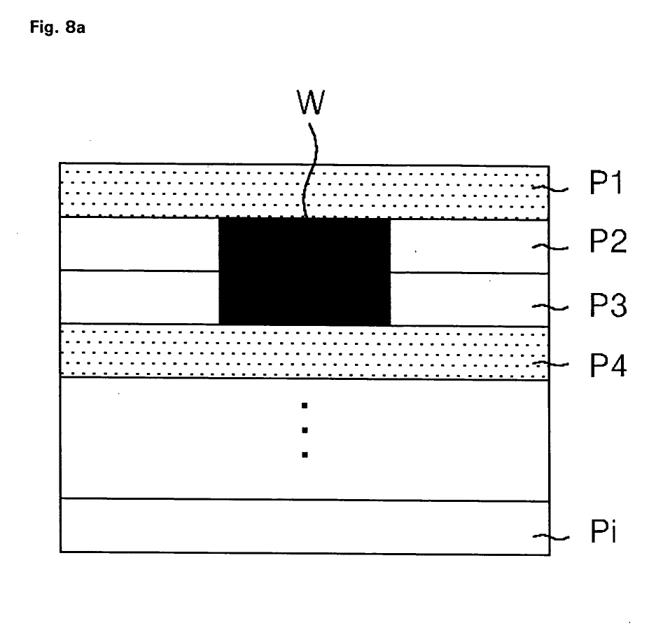

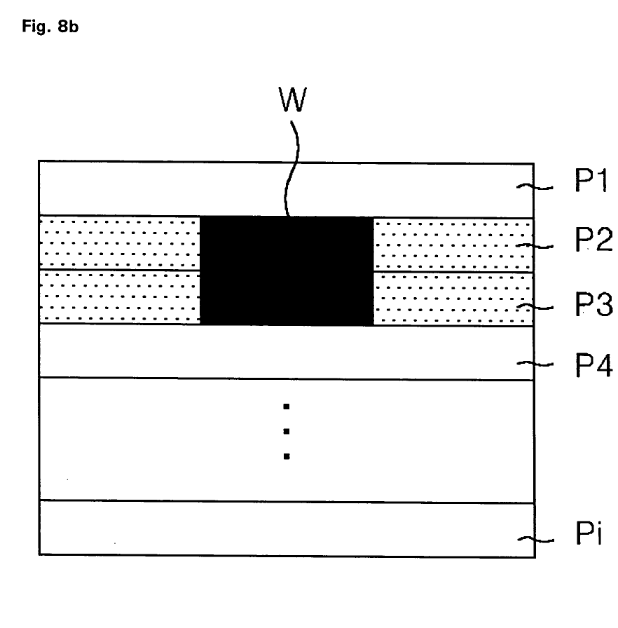

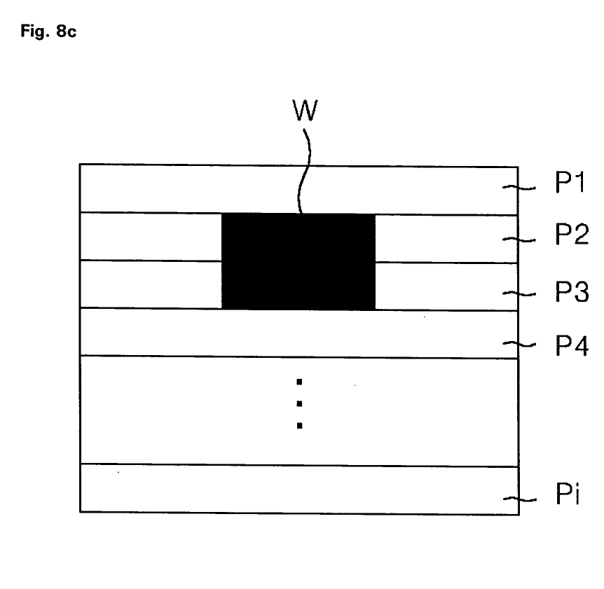

FIGS. 8A to 8C are cross-sectional diagrams for explaining a method of driving a plasma display panel according to a second embodiment of the present invention.

Referring to FIGS. 8A to 8C, first of all, a window area W of black gray is implemented on a specific area in second and third pixel areas P2 and P3 corresponding to second and third horizontal lines, respectively. And, in order to provide the same brightness to the second and third pixel areas P2 and P3 except the window area W and first and fourth pixel areas P1 and P4 corresponding to first and fourth horizontal lines, data of the same level are supplied to the first to fourth pixel areas P1 to P4.

In doing so, loads included in the data that will be supplied to the second and third pixel areas P2 and P3 including the window area W are relatively greater than those of the data that will be supplied to the first and fourth pixel areas P1 and P4.

In this case, the second or third pixel area P2 or P3 excluding the window area W, as shown in FIG. 8A, looks relatively brighter than the first or fourth pixel area P1 or P4 to which the data of the same level of the second or third pixel area is supplied.

Hence, the first comparison unit 112A compares the load included in the second data stored in the line buffer unit 110 to be supplied to the second pixel area P2 corresponding to the second horizontal lines to the load included in the third data stored in the line buffer unit 110 to be supplied to the third pixel area corresponding to the third horizontal lines and then computes a difference between the loads included in the second and third data. If there is no load difference between the second and third data, the second comparison unit 112B compares the third data stored in the line buffer unit 110 to the fourth data to be supplied to the fourth pixel area P4 corresponding to fourth horizontal lines and then computes a load difference between the third and fourth data.

Subsequently, the data converting unit 120 corrects the second and third data in proportion to the load difference. Namely, the data, which will be supplied to the second or third pixel area P2 or P3 except the window area W, as shown in FIG. 8B, is corrected to have a level relatively lower than that of the data that will be supplied to the first or fourth pixel area P1 or P4 and is then supplied to the second or third pixel area P2 or P3, whereby the first to fourth pixel areas P1 to P4 can be provided with the same brightness.

Thus, the level of the data, which will be supplied to the second or third pixel area P2 or P3 looking relatively brighter than the first or fourth pixel area P1 or P4, is lowered, whereby the brightness of the first to fourth pixel areas P1 to P4 becomes identical.

Accordingly, in the apparatus for driving the plasma display panel and method thereof according to the present invention, the loads included in the previous and current lines are computed to correct the data to be supplied to the lines according to the load difference between the respective lines, respectively. Therefore, the present invention enables to correct the brightness difference between the horizontal lines and to prevent power dispersion of the heavily-loaded horizontal line.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for driving a plasma display panel, comprising:
a line buffer unit synchronizing data inputted from outside with a horizontal synchronization signal to store per horizontal line;
at least one comparison unit comparing loads included in horizontal lines stored in the line buffer unit; and
a data converting unit correcting the data to be supplied to the horizontal lines using a load difference resulting from a comparison by the at least one comparison unit.

2. The apparatus of claim 1, wherein the at least one comparison unit comprises a comparison unit comparing the load included in the data having been supplied to a previous horizontal line to the load included in the data to be supplied to a current horizontal line.

3. The apparatus of claim 1, the at least one comparison unit comprising:
a first comparison unit comparing the load included in the data supplied to a kth horizontal line to the load included in the data supplied to a (k+1)th horizontal line; and
a second comparison unit comparing the load included in the data supplied to the (k+1)th horizontal line to the load included in the data supplied to a (k+2)th horizontal line if the loads compared by the first comparison unit are identical to each other.

4. A method of driving a plasma display panel, comprising the steps of:
detecting loads included in externally inputted data to be supplied to at least two adjacent horizontal lines; and
correcting the data to be supplied to each of the at least two adjacent horizontal lines according to a load difference between the at least two adjacent horizontal lines.

5. The method of claim 4, the step of detecting the loads included in the externally inputted data to be supplied to the at least two adjacent horizontal lines, comprising the steps of:
detecting a first load value included in a first externally inputted data supplied to first horizontal lines; and
detecting a second load value included in a second externally inputted data to be supplied to second horizontal lines synchronized with a horizontal synchronization signal.

6. The method of claim 5, the step of correcting the data to be supplied to each of the at least two adjacent horizontal lines according to the load difference between the at least two adjacent horizontal lines, comprising the steps of:
if a difference between the first and second load values is equal to or greater than a prescribed value, correcting the data to be relatively lower than the second data; and
supplying the corrected data to the second horizontal lines.

7. The method of claim 5, the step of correcting the data to be supplied to each of the at least two adjacent horizontal lines according to a load difference between the at least two adjacent horizontal lines, comprising the steps of:
if a difference between the first and second load values is smaller than a prescribed value, correcting the data to be relatively higher than the second data; and
supplying the corrected data to the second horizontal lines.

8. The method of claim 4, the step of detecting the loads included in the externally inputted data to be supplied to the at least two adjacent horizontal lines, comprising the steps of:
detecting a first load value included in a first externally inputted data supplied to a first horizontal line;
detecting second load values included in second externally inputted data supplied to at least two second horizontal lines, respectively; and
detecting a third load value included in a third externally inputted data supplied to a third horizontal line.

9. The method of claim 8, wherein the second load values included in the data to be supplied to the at least two second horizontal lines, respectively are equal to each other.

10. The method of claim 8, the step of correcting the data to be supplied to each of the at least two adjacent horizontal lines according to the load difference between the at least two adjacent horizontal lines, comprising the steps of:
comparing the first and second load values of the first and second horizontal lines;
if a difference between the first and second load values is equal to or greater than a prescribed value, correcting the data to be relatively lower than the second data; and
supplying the corrected data to the second horizontal lines.

11. The method of claim 8, the step of correcting the data to be supplied to each of the at least two adjacent horizontal lines according to the load difference between the at least two adjacent horizontal lines, comprising the steps of:
comparing the first and second load values of the first and second horizontal lines;
if a difference between the first and second load values is smaller than a prescribed value, correcting the data to be relatively higher than the second data; and
supplying the corrected data to the second horizontal lines.
